(19) United States
(12) Patent Application Publication
(10) Pub. No.: US 2019/0381839 A1
(43) Pub. Date: Dec. 19, 2019

(54) BEAD REINFORCING DEVICE FOR PNEUMATIC TIRES

(71) Applicant: Hankook Tire Co., Ltd., Seoul (KR)

(72) Inventor: Kyung Ho KIM, Daejeon (KR)

(73) Assignee: Hankook Tire Co., Ltd., Seoul (KR)

(21) Appl. No.: 16/207,763

(22) Filed: Dec. 3, 2018

(30) Foreign Application Priority Data
Jun. 15, 2018 (KR) 10-2018-0069011

(51) Int. Cl. B60C 15/00; B60C 15/04; B60C 15/06

(52) U.S. Cl. CPC B60C 15/0009; B60C 2015/044; B60C 15/0603; B60C 15/04

(57) ABSTRACT

Disclosed herein is a bead reinforcing device for pneumatic tires, which includes a bead forming a circumference of a tire as a portion where the tire is in contact with a wheel, a carcass formed to cover the bead from its inside to its outside and forming an entire frame of the tire, and a bead stiffener formed to cover an entire outer surface of the bead.

### BACKGROUND OF THE INVENTION

### Field of the Invention

The present invention relates to a bead reinforcing device for pneumatic tires, and more particularly, to a bead reinforcing device for a reduction in weight and an improvement in dynamic characteristics of a tire having a low aspect ratio by covering an entire outer surface of a bead of the tire.

### Description of the Related Art

In recent years, automobile and auto parts companies are rapidly expanding the application of ultra-high performance tires (UHPTs) for various purposes such as responding to the advanced driving performance of vehicles and improving the appearances thereof. These ultra-high performance tires generally refer to tires each having a rim diameter of 16 inches or more and a low aspect ratio of 55 or less to specialize in high-speed driving, although there may be differences in standards for each manufacturer.

The low aspect ratio of 55 or less exhibits excellent handling stability in high-speed driving conditions, and provides excellent safety performance to vehicles by excellent braking ability. In order to provide stable driving performance at high speed of 240 km/h or more, many automobile and auto parts companies are focusing on techniques for reinforcing tire beads to improve the dynamic characteristics of tires in recent years.

The tire bead means a portion for fixing a tire to a rim, and the stiffness of the bead filler portion extending from the bead to the sidewall of the tire has a great influence on the dynamic performance of the tire. Especially, in an ultra-high performance tire designed specifically for high speed driving, the bead of the tire is particularly important since the dynamic performance of the tire is very important.

However, when the tire is mounted to the vehicle and runs for a long time, problems relating to deterioration in durability and performance of the bead may be caused since the tire must withstand various internal pressures and loads generated during running. Therefore, in order to prevent these problems, there have been proposed techniques for reinforcing the tire bead to improve the durability and dynamic characteristics of the bead.

Existing Korean Patent No. 10-1760876 (Title: Pneumatic Tire with Improved Durability of Bead) discloses a technique for improving durability of a bead by covering the bead with a stiffener to alleviate deformation and stress concentration that may occur at the bead.

In addition, Korean Patent No. 10-1127637 (Title: Heavy-duty Tire with Bead Stiffener) discloses a technique for preventing an occurrence of separation on a tire carcass end during use of the heavy-duty tire by installing a stiffener on the inner surface of a bead.

The bead reinforcement according to the existing patent techniques is of a type, in which the entire outer surface of the bead is not covered or only a portion of the bead is covered, which is useful for the tire having a high aspect ratio. However, there is a problem in that the bead reinforcement is not usable for the tire having a low aspect ratio or has very low efficiency in use.

Accordingly, for a tire having a low aspect ratio, there is a need to present a new technique for reinforcing a bead and achieving a reduction in weight and an improvement in dynamic characteristics of the tire.

### CITATION LIST

### Patent Literature

Patent Literature 1: Korean Patent No. 10-1760876

Patent Literature 2: Korean Patent No. 10-1127637

### SUMMARY OF THE INVENTION

The present invention has been made in view of the above-mentioned problems, and an object thereof is to provide a bead reinforcing device for improving durability and dynamic performance of a tire having a low aspect ratio by covering an entire outer surface of a bead of the tire in order to expand application of an existing bead reinforcing method through a bead stiffener to the tire.

The present invention is not limited to the above-mentioned object, and other objects of the present invention can be clearly understood by those skilled in the art to which the present invention pertains from the following description.

To accomplish the object described above, a bead reinforcing device for pneumatic tires according to an aspect of the present invention includes a bead forming a circumference of a tire as a portion where the tire is in contact with a wheel, a carcass formed to cover the bead from its inside to its outside and forming an entire frame of the tire, and a bead stiffener formed to cover an entire outer surface of the bead.

In the aspect of the present invention, the bead may include a bead wire having a steel wire formed at the center thereof and a bead filler formed to cover the bead wire.

In the aspect of the present invention, the bead reinforcing device may further include a rubber sheet disposed to come into contact with a portion of the side surface of the bead.

In the aspect of the present invention, the bead stiffener may be made of a textile material.

In the aspect of the present invention, the bead stiffener may be a first bead stiffener including a first outer bead stiffener formed to cover an entire outer surface of the bead and a first inner bead stiffener formed to cover an entire inner surface of the bead.

In the aspect of the present invention, the bead stiffener may be a second bead stiffener including a second outer bead stiffener formed to cover an entire outer surface of the bead and a second inner bead stiffener formed to cover a partial inner surface of the bead.

In the aspect of the present invention, the rubber sheet may be a first rubber sheet positioned between the parts of the bead stiffener and configured to cover a portion of the outer or inner surface of the bead.

In the aspect of the present invention, the first rubber sheet may be formed to protrude more than an end of the first inner bead stiffener.

In the aspect of the present invention, an upper end of the first inner bead stiffener may be formed to protrude more than that of the first outer bead stiffener.

In the aspect of the present invention, the first rubber sheet may be formed to cover the outer and inner surfaces of the bead.

In the aspect of the present invention, the rubber sheet may be a second rubber sheet configured to cover an inner surface of the bead which is not covered by the bead stiffener.

In the aspect of the present invention, the second rubber sheet may be formed to protrude more than an upper end of the second outer bead stiffener.

In the aspect of the present invention, an upper end of the second outer bead stiffener may be formed to protrude more than that of the bead.

In the aspect of the present invention, the second inner bead stiffener may be formed to cover the inner surface of the bead.

### BRIEF DESCRIPTION OF THE DRAWINGS

FIG. 1 is a schematic view illustrating a general structure of a pneumatic tire.

FIG. 2A is a cross-sectional view illustrating a bead reinforcing device of a type that does not cover an outer surface of a bead according to the related art.

FIG. 2B is a cross-sectional view illustrating a bead stiffener of a type that covers only a portion of the outer surface of the bead (Half Bead Packing) according to the related art.

FIG. 3 is a cross-sectional view illustrating a bead reinforcing device of a type that fully covers outer and inner surfaces of a bead (Full Bead Packing) according to an embodiment of the present invention.

FIG. 4 is a cross-sectional view illustrating a bead reinforcing device of a type that covers an entire outer surface of a bead and only a portion of an inner surface thereof (Mixed Bead Packing) according to an embodiment of the present invention.

FIG. 5A is a table illustrating the weight of a tire in which HBP bead reinforcement is applied to a bead filler of 40 mm according to the related art.

FIG. 5B is a table illustrating the weight of a tire in which FBP bead reinforcement is applied to a bead filler of 20 mm according to the embodiment of the present invention.

FIG. 6A is an experimental data graph obtained by comparing tire cornering stiffness between when the HBP bead reinforcement is applied to the bead filler of 40 mm according to the related art and when the FBP bead reinforcement is applied to the bead filler of 20 mm according to the embodiment of the present invention.

FIG. 6B is an experimental data graph obtained by comparing tire peak grip between when the HBP bead reinforcement is applied to the bead filler of 40 mm according to the related art and when the FBP bead reinforcement is applied to the bead filler of 20 mm according to the embodiment of the present invention.

### DETAILED DESCRIPTION OF THE PREFERRED EMBODIMENTS

Reference will now be made in detail to exemplary embodiments of the present invention, examples of which are illustrated in the accompanying drawings. The present invention may, however, be embodied in different forms and should not be construed as limited to the embodiments set forth herein. For clear explanation of the present invention, parts irrelevant to the description may be omitted in the drawings, and like reference numerals refer to like parts throughout the specification.

In the whole specification, it will be understood that when an element is referred to as being “connected (joined, contacted, or coupled)” to another element, it can be “directly connected” to the other element or it can be “indirectly connected” to the other element with other elements being interposed therebetween. In addition, it will be understood that when a component is referred to as “comprising or including” any component, it does not exclude other components, but can further comprise or include the other components unless otherwise specified.

The terminology used in the present disclosure is for the purpose of describing particular embodiments only and is not intended to limit the invention. As used in the disclosure and the appended claims, the singular forms “a”, “an” and “the” are intended to include the plural forms as well, unless context clearly indicates otherwise. It will be further understood that the terms “comprises/includes” and/or “comprising/including” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, exemplary embodiments of the present invention will be described in detail with reference to the accompanying drawings.

A bead reinforcing device for pneumatic tires according to an embodiment of the present invention will be described below in more detail with reference to the accompanying drawings.

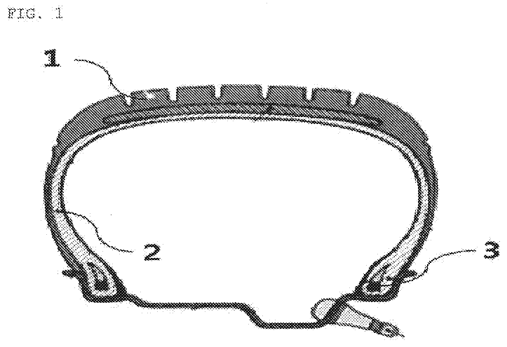

FIG. 1 illustrates a general structure of a pneumatic tire. The pneumatic tire largely includes a tread 1 composed of a thick rubber layer coming into direct contact with the road surface, a carcass 2 corresponding to the frame of the tire while serving to withstand the load of a vehicle, and a bead 3 serving to mount the tire to a rim.

The stiffness of a portion extending from the bead 3 of the tire to a sidewall, which is the side surface of the tire, has a direct and great influence on the dynamic performance of the tire. However, since the tire must withstand various loads generated by running for a long time, deterioration in durability, deformation, and the like may occur in the bead 3, which is directly related to deterioration in dynamic performance of the tire.

Therefore, technology is needed for reinforcing the bead 3 to improve the dynamic performance of the tire and preventing stress from concentrating on the bead 3 to maintain durability.

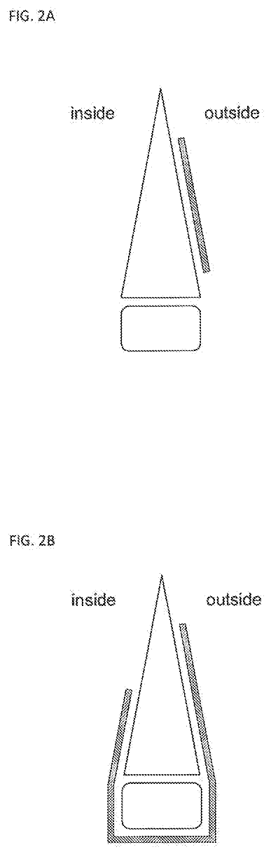

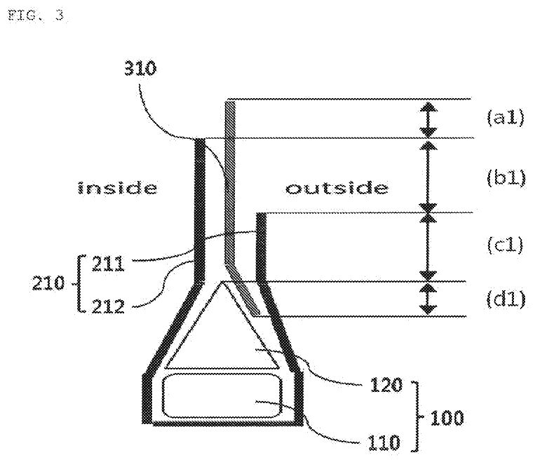

FIGS. 2A and 2B are a cross-sectional view illustrating an existing bead reinforcing device of a type in which only a portion of an outer surface of a bead is covered with a bead stiffener (Half Bead Packing).

This tire bead is covered with the bead stiffener for reinforcement to be protected from large deformation of a flange and to improve overall durability by preventing stress concentration. In addition, the reinforcement of the bead can contribute to the stability of the vehicle by increasing stiffness, minimizing the deformation of the vehicle, and improving the handling of the vehicle.

The existing bead stiffener and bead reinforcing method illustrated in the drawing are useful for the tire having a high aspect ratio, but they are not usable for the tire having a low aspect ratio or have very low efficiency in use.

The aspect ratio of the tire means a ratio obtained by multiplying the section height of a tire divided by the section width thereof by 100, and is also referred to as a series. In general, a high aspect ratio has the advantage of good ride comfort, but it is disadvantageous in that handing stability, braking ability, or the like is unstable when the vehicle travels at high speed or corners. Accordingly, the tire having a low aspect ratio is classified as a high performance tire.

In recent years, a variety of vehicles with high performance have been introduced in automobile and auto parts markets, and ultra-high performance tires (UHPTs) that can support the performance have been rapidly commercialized. These ultra-high performance tires (UHPTs) generally refer to tires meeting conditions of a rim diameter of 16 inches or more, a low aspect ratio of 55 or less, and a speed rating of V-rating (240 Km/h) or more, although there may be differences in standards for each manufacturer.

Since each of the ultra-high performance tires (UHPTs) has a low aspect ratio and a strong sidewall, the slip of the tire is reduced and braking performance is improved, thereby reducing a standing wave phenomenon to increase a drivable maximum limit speed. In addition, the ultra-high performance tire is designed such that its heat generation rate is low together with block performance optimized for fast driving, thereby maintaining stable ride comfort even during running at high speed.

Accordingly, in order to improve the dynamic performance and durability of the tire bead corresponding to the performance of the ultra-high performance tire, attention is focused on a technique for reinforcing the tire bead having a low aspect ratio.

The present invention provides a bead reinforcing device for tires, in which the existing bead reinforcing device and bead reinforcing method are extended to a low-aspect-ratio tire mainly constituting an ultra-high performance tire (UHPT), for achieving a reduction in weight and an improvement in dynamic performance of the tire and compensating conventionally various disadvantages.

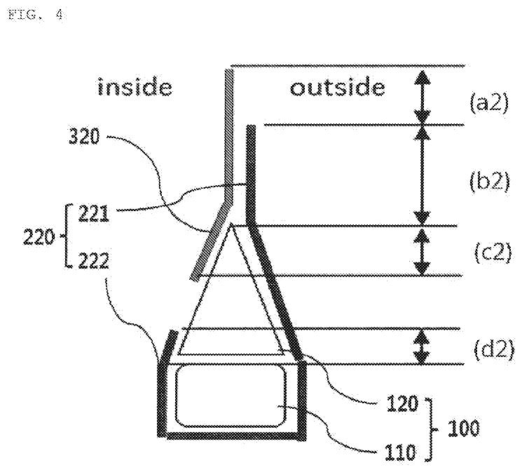

FIGS. 3 and 4 are cross-sectional views illustrating a bead reinforcing device that covers an entire outer surface of a bead 100 with a bead stiffener 200 according to an embodiment of the present invention.

The bead 100 is a portion where a tire is in contact with a wheel and serves to connect the tire to a rim. The bead 100 has a ring shape along the circumference of the tire, and includes a bead wire 110 having a steel wire formed at the center thereof and a bead filler 120 formed to cover the bead wire 110.

The bead stiffener in the existing bead reinforcing method is mainly made of steel, aramid, or nylon. In contrast, the embodiment of the present invention is characterized in that the bead stiffener 200 is made of a textile material.

In the case where the bead stiffener 200 is made of a textile material, the original purpose of reinforcement of the bead 100 is advantageous in that it is relatively easy to manufacture and manage the bead in addition to the improvement of durability as compared with the existing reinforcement material.

Considering that the present invention specializes in the low-aspect-ratio tire, it will be preferable that the bead 100 has a height of 10 mm to 20 mm. However, the height of the bead 100 is not limited to that described above, and the bead 100 having various heights may be applied as required.

According to the embodiment of the present invention, a rubber sheet 300 may be included between the parts of the bead stiffener 200 or between the bead stiffener 200 and the carcass 400. The addition of the rubber sheet 300 is effective in preventing the separation of semi-finished products which may be caused by covering the bead 100 with the bead stiffener 200.

FIG. 3 is a cross-sectional view illustrating a bead reinforcing device of a type that fully covers outer and inner surfaces of a bead 100 with a first bead stiffener 210 (Full Bead Packing) according to an embodiment of the present invention. The first bead stiffener 210 includes a first outer bead stiffener 211 that covers the outer surface of the bead 100 and a first inner bead stiffener 212 that covers the inner surface of the bead 100.

According to the embodiment of the present invention, a first rubber sheet 310 may be applied between the parts of the first bead stiffener 210. The first rubber sheet 310 may be positioned between the parts of the first bead stiffener 210 and configured to cover a portion of a side surface of a bead filler 120.

For the proper application of the present invention, the length cl illustrated in FIG. 3 may be selectively applied according to mold profiles and standards, and it is preferable that the lengths a1 and d1 are about 5 mm and the length b1 is about 7 mm.

FIG. 4 is a cross-sectional view illustrating a bead reinforcing device of a type that covers an entire outer surface of a bead 100 and a portion of an inner surface thereof with a second bead stiffener 220 (Mixed Bead Packing) according to an embodiment of the present invention. The second bead stiffener 220 includes a second outer bead stiffener 221 that covers the outer surface of the bead 100 and a second inner bead stiffener 222 that covers the inner surface of the bead 100.

Through such a configuration, a second rubber sheet 320 may be applied between a portion of the inner surface of the bead 100, which is not covered by the second bead stiffener 220, and the carcass 400 to cover the uncovered inner surface of the bead 100.

For the proper application of the embodiment of the present invention, the length c2 illustrated in FIG. 4 may be selectively applied according to mold profiles and standards, and it is preferable that the lengths a2 and d2 are about 5 mm and the length b2 is about 3 mm.

However, the application positions, lengths, or the like of the bead stiffener 200 and rubber sheet 300 of the present invention are not limited to those described above, and may be appropriately changed and used for the proper application of the present invention.

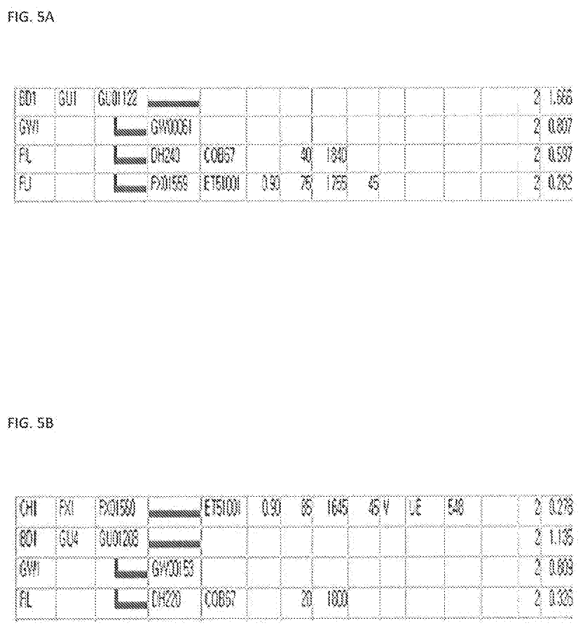

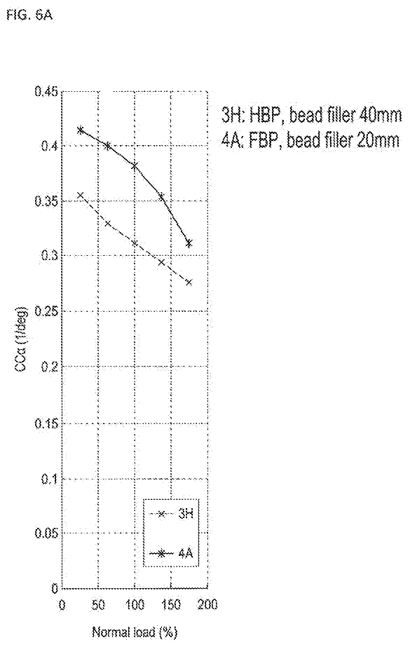

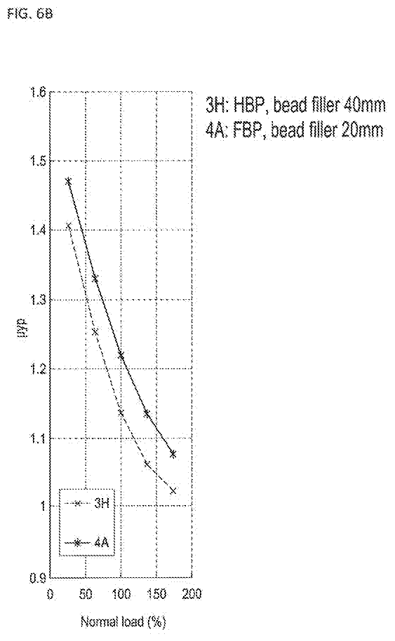

The specific effects of application of the present invention will be described in detail with reference to the tables and graphs attached to FIGS. 5 and 6.

FIGS. 5A and 5B illustrates Table (a) showing the weight of a tire in which bead reinforcement of a type that covers a partial surface of a bead (Half Bead Packing) is applied to a bead filler of 40 mm according to the related art, and Table (b) showing the weight of a tire in which bead reinforcement of a type that covers an entire surface of a bead 100 (Full Bead Packing) is applied to a bead filler 120 of 20 mm according to the embodiment of the present invention.

The total weight of the tire with reinforced beads according to the related art is 1.666 kg as shown in Table (a), the total weight of the tire with reinforced beads according to the present invention is 1.413 kg as shown in Table (b).

Through the results of the experimental tables (a) and (b), it can be seen that the tire to which the bead reinforcement (Full Bead Packing) of the present invention is applied is reduced in weight by 200 g or more compared to the low-aspect-ratio tire, namely the tire having a low section height, to which the bead reinforcement (Half Bead Packing) of the related art is applied.

FIG. 6A is an experimental data graph obtained by comparing cornering stiffness between when the bead reinforcement of the type that covers the partial surface of the bead (Half Bead Packing) is applied to the bead filler of 40 mm according to the normal load in the related art and when the bead reinforcement of the type that covers the entire surface of the bead 100 (Full Bead Packing) is applied to the bead filler 120 of 20 mm according to the embodiment of the present invention.

The cornering stiffness refers to a differential value at which a side force occurs at a slip angle of 0 degrees according to the relationship between the slip angle of the tire and the side force thereof. The cornering stiffness is a reference magnitude of the force generated when the direction of the tire in progress is changed, and is a factor affecting the handling and stability of the vehicle. In general, the tire has excellent dynamic performance as the cornering stiffness is high.

FIG. 6B is an experimental data graph obtained by comparing peak grip between when the bead reinforcement of the type that covers the partial surface of the bead (Half Bead Packing) is applied to the bead filler of 40 mm according to the normal load in the related art and when the bead reinforcement of the type that covers the entire surface of the bead 100 (Full Bead Packing) is applied to the bead filler 120 of 20 mm according to the embodiment of the present invention.

In the graph (a), the influence for each structure may be somewhat different, but it can be seen that the application of the bead reinforcement according to the present invention allows the cornering stiffness to be increased by about 5 to 15% or more. In the graph (b), it can be seen that the application of the bead reinforcement according to the present invention allows the peak grip to be also increased.

The increased effect of the cornering stiffness by 5% or more corresponds to a degree of change that is hardly seen without changing the constituent compounds of the tire. In view of above experimental data, it can be seen that the present invention has a remarkably excellent effect in improving the dynamic performance of the tire compared to the related art.

The effect of static characteristics according to the application of the present invention will be described in detail with reference to the following Table 1.

TABLE 1

| | HBP | FBP |
|---|---|---|
| Kv | 100% | 78% |
| Kd | 100% | 151% |

In the above Table 1, it can be seen that the application of the bead reinforcement according to the present invention allows the distortional stiffness of the tire to be increased by about 51% due to the change of the Kd value and the vertical stiffness thereof is reduced by about 22% due to the change of the Kv value, compared to the related art.

Accordingly, since the vertical stiffness is reduced by applying the bead reinforcement of the present invention to the low-height bead filler, it can be expected to improve enveloping characteristics allowing the tire to absorb impact, the comfort of the vehicle, etc. as a whole.

According to the present invention, it is possible to reduce the weight of the tire and improve the static/dynamic characteristics thereof by expanding the application of the conventional bead reinforcing device and method for tire beads to the tire having a low aspect ratio and to simultaneously compensate conventionally various disadvantages.

Since the bead stiffener 200 is made of the textile according to the embodiment of the present invention, the present invention can be advantageous in terms of management in addition to durability. Since the rubber sheet 300 is applied between the inner or outer reinforcements of the bead 100, it is possible to prevent a separation phenomenon due to the application of different materials.

The present invention with the above-mentioned configuration has an effect of providing the bead reinforcing device suitable for the tire having a low aspect ratio, thereby reducing the weight of the tire and improving the dynamic performance of the tire as compared with the existing technology.

In addition, the present invention has an effect of increasing the durability of the bead and its efficiency in terms of management by means of the bead stiffener made of a textile while preventing the separation of semi-finished products due to the application of different materials by applying the rubber sheet between the parts of the bead stiffener.

The present invention is not limited to the above effects, and it should be understood that the present invention includes all effects which can be inferred from the detailed description of the present invention or the configuration of the invention defined by the appended claims.

The above-mentioned embodiments of the present invention are merely examples, and it will be understood by those skilled in the art that various modifications may be made without departing from the spirit and scope or essential features of the invention. Therefore, it should be understood that the embodiments described above are for purposes of illustration only in all aspects and are not intended to limit the scope of the present invention. For example, each component described in a single form may be implemented in a distributed form, and similarly, components described in the distributed form may be implemented in a combined form.

The scope of the present invention is defined by the appended claims, and it should be construed that all modifications or variations derived from the meaning, scope, and equivalent concept of the claims fall within the scope of the invention.

1. A bead reinforcing device for pneumatic tires, the device comprising:
a bead forming a circumference of a tire as a portion where the tire is in contact with a wheel;
a carcass formed to cover the bead from its inside to its outside and forming an entire frame of the tire; and
a bead stiffener formed to cover an entire outer surface of the bead.

2. The bead reinforcing device according to claim 1, wherein the bead comprises;
a bead wire having a steel wire formed at the center thereof; and
a bead filler formed to cover the bead wire.

3. The bead reinforcing device according to claim 1, further comprising:
a rubber sheet disposed to come into contact with a portion of a side surface of the bead.

4. The bead reinforcing device according to claim 1, wherein the bead stiffener is made of a textile material.

5. The bead reinforcing device according to claim 1, wherein the bead stiffener is a first bead stiffener comprising:
a first outer bead stiffener formed to cover an entire outer surface of the bead; and
a first inner bead stiffener formed to cover an entire inner surface of the bead.

6. The bead reinforcing device according to claim 1, wherein the bead stiffener is a second bead stiffener comprising:
a second outer bead stiffener formed to cover an entire outer surface of the bead; and
a second inner bead stiffener formed to cover a partial inner surface of the bead.

7. The bead reinforcing device according to claim 5, wherein a first rubber sheet is positioned between parts of the bead stiffener and configured to cover a portion of an outer or inner surface of the bead.

8. The bead reinforcing device according to claim 7, wherein the first rubber sheet is formed to protrude more than an upper end of the first inner bead stiffener.

9. The bead reinforcing device according to claim 7, wherein an upper end of the first inner bead stiffener is formed to protrude more than that of the first outer bead stiffener.

10. The bead reinforcing device according to claim 7, wherein the first rubber sheet is formed to cover outer and inner surfaces of the bead.

11. The bead reinforcing device according to claim 6, wherein a second rubber sheet is configured to cover an inner surface of the bead which is not covered by the bead stiffener.

12. The bead reinforcing device according to claim 11, wherein the second rubber sheet is formed to protrude more than an upper end of the second outer bead stiffener.

13. The bead reinforcing device according to claim 11, wherein an upper end of the second outer bead stiffener is formed to protrude more than that of the bead.

14. The bead reinforcing device according to claim 11, wherein the second inner bead stiffener is formed to cover the inner surface of the bead.

15. The bead reinforcing device according to claim 2, wherein the bead stiffener is a first bead stiffener comprising:
a first outer bead stiffener formed to cover an entire outer surface of the bead; and
a first inner bead stiffener formed to cover an entire inner surface of the bead.

16. The bead reinforcing device according to claim 15, wherein the bead stiffener is a second bead stiffener comprising:
a second outer bead stiffener formed to cover an entire outer surface of the bead; and
a second inner bead stiffener formed to cover a partial inner surface of the bead.
